(19) United States
(12) Patent Application Publication
(10) Pub. No.: US 2012/0132307 A1
(43) Pub. Date: May 31, 2012

(54) ARRANGEMENT FOR TRANSFERRING A FLUID TO A SHIP AND SYSTEM FOR TRANSFERRING FLUID BETWEEN TWO SHIPS, ONE OF WHICH IS PROVIDED WITH THE ARRANGEMENT OF THE INVENTION

(75) Inventor: Stephane Paquet, Septeuil (FR)

(73) Assignee: SOCIETE EUROPEENE D'INGENIERIR MECANIIQUE-EURODIM, Rueil Malmaison cedex (FR)

(21) Appl. No.: 13/266,812

(22) PCT Filed: Apr. 29, 2010
(86) PCT No.: PCT/FR10/50822

§ 371 Date: Jan. 10, 2012

(30) Foreign Application Priority Data
Apr. 30, 2009 (FR) 0952925

(51) Int. Cl. F15D 1/00

(52) U.S. Cl. 137/899.2

(57) ABSTRACT

An arrangement for transferring a fluid, such as liquefied natural gas, to a ship. The arrangement includes a manifold and a device for offsetting a manifold connector beyond an edge of the ship. The device includes a fixed tubular portion connected to the manifold and a mobile tubular portion, mobile between a transfer position, in which the device is connected to a fluid transfer duct, and a rest position, inside the ship. The mobile tubular portion is pivotably mounted between the rest and transfer positions and is connected to the fixed tubular portion in the transfer position, and separated from the fixed tubular portion in the rest position. The manifold connector of the fixed tubular portion is located so that axes of opening apertures of the fixed and mobile tubular portions coincide in the transfer position of the mobile tubular portion.

### FIELD OF THE INVENTION

The invention relates to an arrangement for transferring a fluid, such as liquefied natural gas, to a ship, wherein the arrangement is provided on the ship and includes a manifold connected to a tank of the ship and a device for offsetting the manifold connector at least as far as the outer edge of the ship and advantageously beyond it, the offsetting device comprising a tubular portion mounted fixed on the structure of the ship and connected to the manifold and a tubular portion that is mobile between a transfer position in which the outer end thereof supporting the offset connector of the manifold is connected to a fluid transfer duct, and a stowed rest position inside the ship relative to the outer edge thereof.

The invention also relates to a system for transferring a fluid between two ships placed side-by-side, one of which is a ship for storing the fluid and the other of which is the ship equipped with the transfer arrangement according to the invention.

### BACKGROUND

A transfer arrangement of this type is already known from international patent application WO2008/132417. This arrangement has a relatively complex structure inasmuch as the inner end of the mobile tubular portion is connected to the outer end of the fixed tubular portion by a swing joint allowing the mobile portion to rotate between these rest and transfer positions.

The invention aims to propose a simplified mobile structure by avoiding such a swing joint.

### SUMMARY OF THE INVENTION

To achieve that aim, the transfer arrangement according to the invention is characterized in that the mobile tubular portion is pivotably mounted on the structure of the ship, between its rest and transfer positions, the outer and inner ends of the fixed and mobile tubular portions are provided with connectors connected to one another in the transfer position of the mobile portion, but separated in the rest position thereof, and in that the connector of the fixed portion is situated on the arc of circle of the pivoting movement of the inner connector of the mobile portion so that the axes of the opening orifices toward the outside of the two connectors are combined in the transfer position of the mobile portion.

According to one advantageous feature of the invention, the mobile portion pivots around a substantially vertical axis, the axes of the opening orifices of the connectors of the fixed and mobile tubular portions being oriented substantially horizontally.

The transfer system between a first ship for transporting a fluid and a second ship, which are placed side-by-side during a transfer, is characterized in that the second ship is equipped with the transfer arrangement according to the invention.

### BRIEF DESCRIPTION OF DRAWING FIGURES

The invention will be better understood, and other aims, features, details and advantages thereof will appear more clearly in the following explanatory description done in reference to the appended diagrammatic drawings provided solely as examples illustrating one embodiment of the invention and in which:

FIG. 1 is a top view of a system for transferring a fluid between a first storage ship and a second ship;

FIG. 2 is a perspective view of the portion of the transfer system according to the invention, which is provided on the storage ship;

FIG. 3 is a perspective view of the second ship and the transfer arrangement that constitutes the portion of the transfer system, which is provided on said second ship;

FIGS. 4 and 5 are perspective views of the transfer arrangement provided on the second ship and show the latter in its fluid transfer and rest positions, respectively;

FIG. 6 is a view in the direction of the longitudinal axis of the two ships and the transfer arrangements, which are provided on the two ships;

FIGS. 7 and 8 are two different perspective views of the transfer arrangement of the second ship in its transfer position;

FIG. 9 is a perspective view of the transfer arrangement of the second ship, showing the latter in its rest position;

FIGS. 10 to 13 show the transfer arrangement provided on the storage ship, in four different phases of the process for connecting the hose to the arrangement of the second ship.

### DETAILED DESCRIPTION

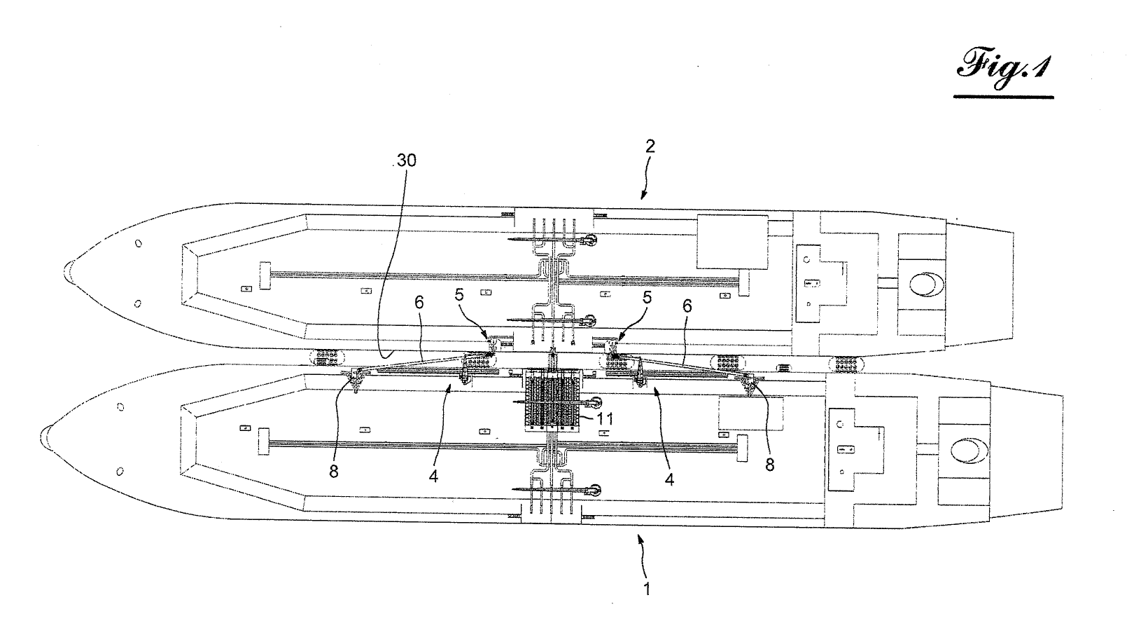

FIG. 1 shows the two ships placed side-by-side at a distance for example comprised between 4.5 and 5 meters, i.e. the first ship 1, for example the storage ship, and a second ship 2, for example a shuttle, each provided with equipment for transferring a fluid, such as liquefied natural gas (LNG). In the illustrated example, the equipment of each ship includes two transfer arrangements, those of the first ship 1 being designated by reference 4, those of the second ship 2 are referenced 5.

The two cooperating arrangement portions 4 and 5 constitute a transfer system according to the invention.

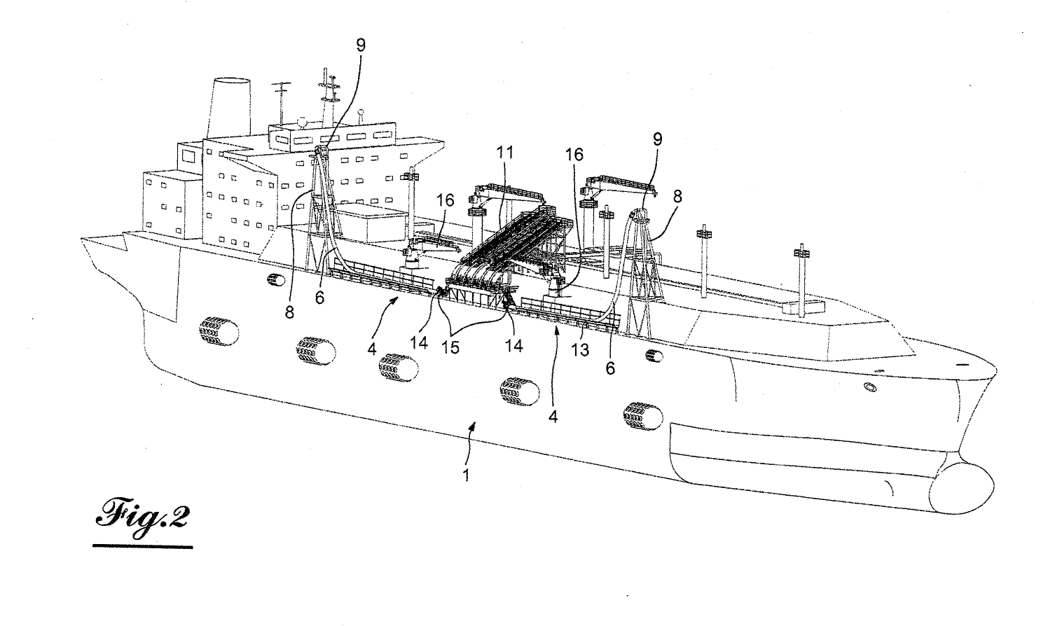

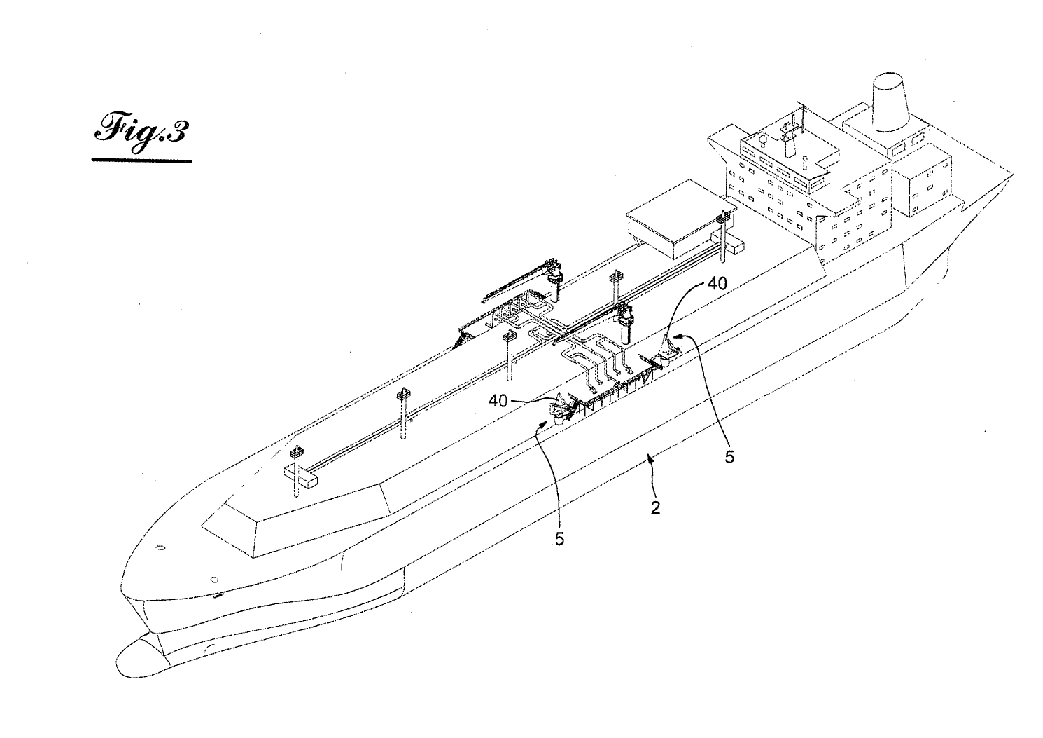

In reference to FIG. 2, a transfer arrangement 4 according to the invention, provided on the storage ship 1, essentially includes a primary flexible transfer duct 6 whereof one end is connected at the apex of a tower structure 8 to a fixed pipeline 9 of the ship. The tower structures 8 are mounted on the ship at a relatively significant distance on either side of the central portion of the ship, which includes a storage device in the form of a tilted rack 11 for a certain number of shorter hoses for transferring a fluid such as liquefied natural gas, at a lower flow rate, and/or the cold return gas. As an example, the ducts are formed by cryogenic hoses designed to transfer liquefied natural gas. These hoses are intended to extend between the two ships, in their transfer position, perpendicular to the longitudinal axes thereof. The device 11 not being part of the present invention, it will not be described below.

The two main hoses 6 having a larger diameter for transferring a fluid at a higher flow rate are relatively long to be able each to be connected to a transfer arrangement 5 provided on the second ship 2 in the central portion thereof.

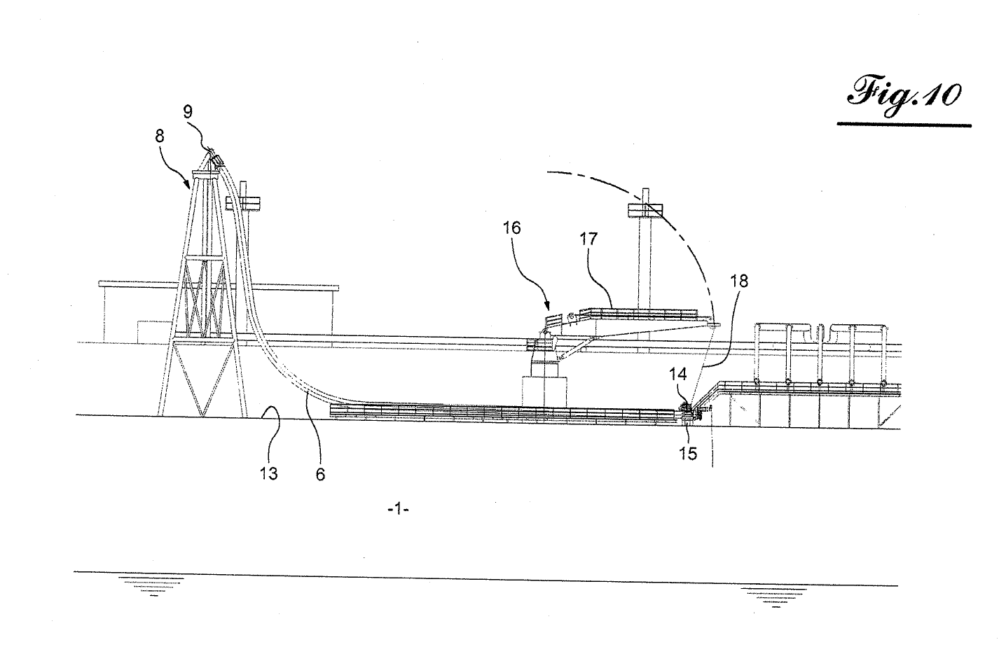

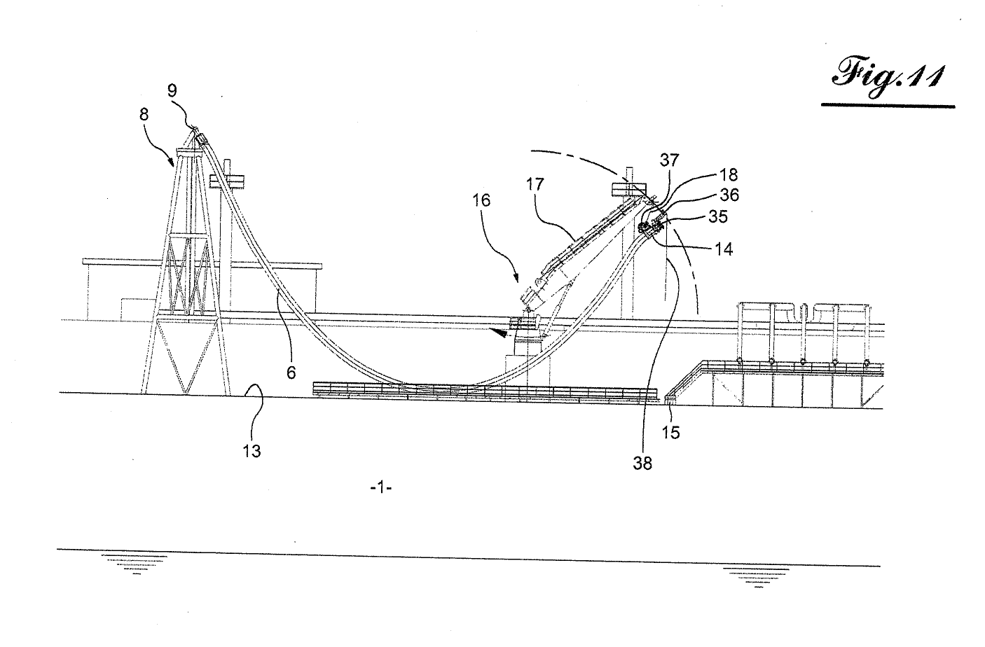

Due to their relatively significant length, the hoses 6 extend substantially vertically from the apex of their support tower structure 8 toward the deck 13 of the ship and then rest thereon, along the edge as far as the central portion where their end 14 is blocked in a suitable retaining device 15. To manipulate the end 14 configured in a connector tip and transfer it to the arrangement 5 of the second ship 2, the arrangement 4 includes, associated with each hose 6, a crane 16 arranged between the support tower 8 and the retaining device 15, at a certain appropriate distance from the latter. The crane rotates around a vertical axis and its arm 17 can pivot around a horizontal axis, as emerges from FIGS. 10 to 13. The tip 14 is suspended from a cable 18 of the crane.

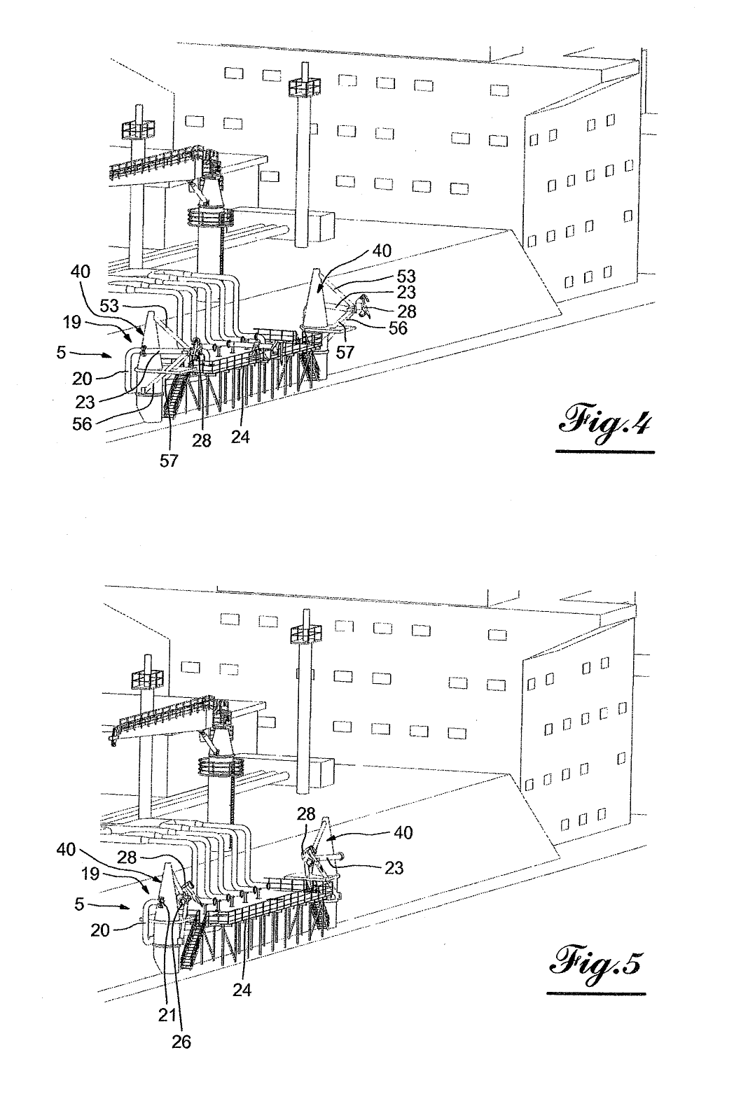

The transfer arrangement 5 provided on the second ship 2, which could be a shuttle, includes, for connecting each hose 6, a device 19 for offsetting the connecting clip of the manifold of the second ship at least as far as the edge thereof and, as in the present case, beyond that edge. Each offsetting device 19 comprises a fixed tubular portion 20 whereof one end is connected to the clip of the manifold while the other end supports a connecting clip 21, and a tubular portion 23 mobile between a rest position shown in FIGS. 5 and 9 and a transfer position shown in FIGS. 4 and 6 to 8. The fixed portion 20 is formed by a tube that comprises several bent portions for the free ends in the form of connecting clips 21 to be placed on either side of a platform 24 in the central portion of the ship. Each connecting clip 21 is located at the end of a tube portion that extends perpendicularly to the longitudinal direction of the ship 2 so that the axis of its clip is oriented horizontally and perpendicularly to that direction.

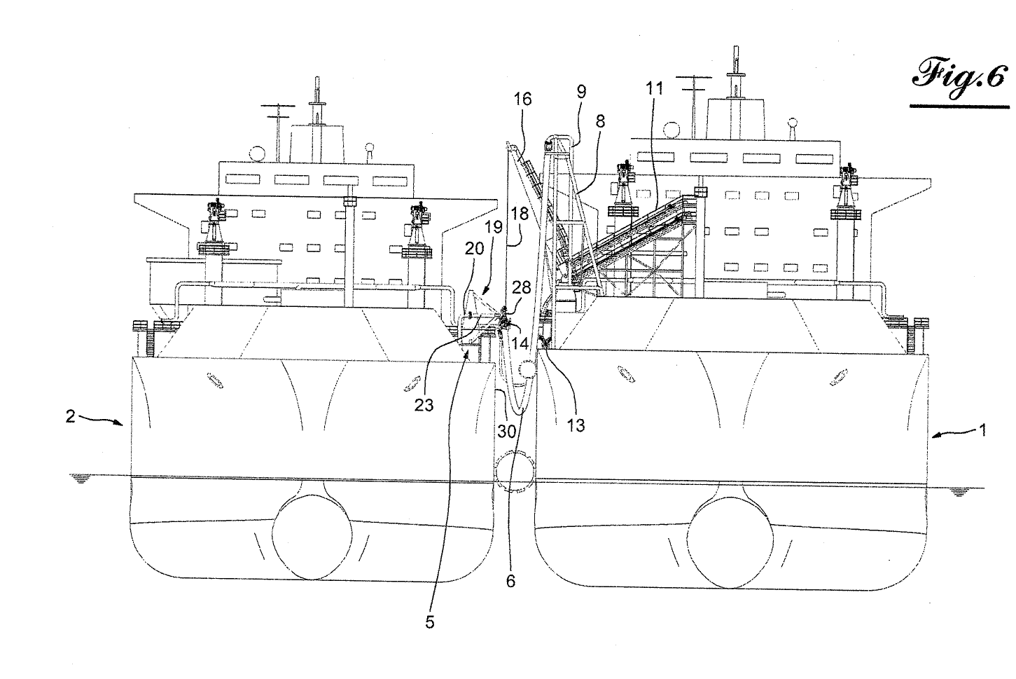

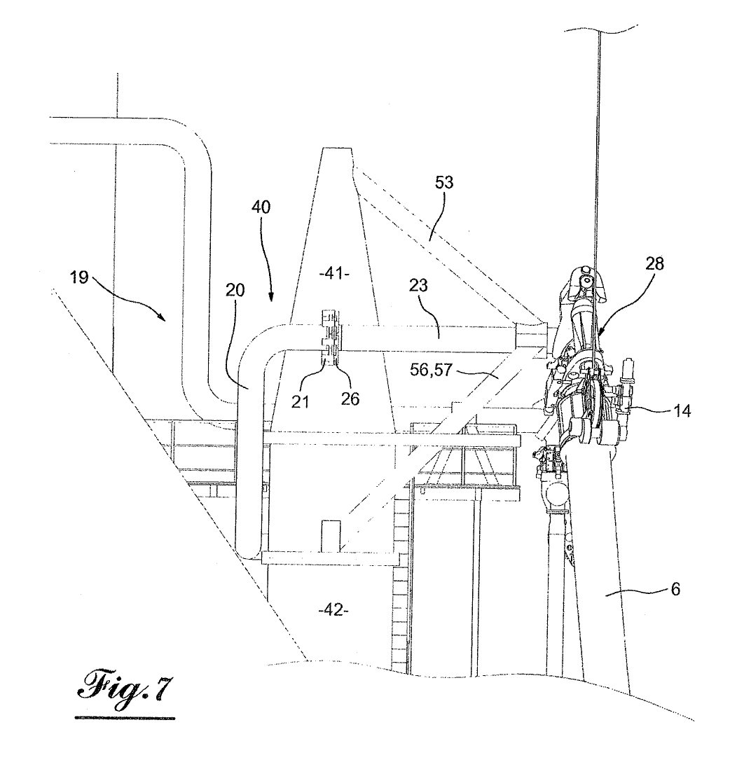

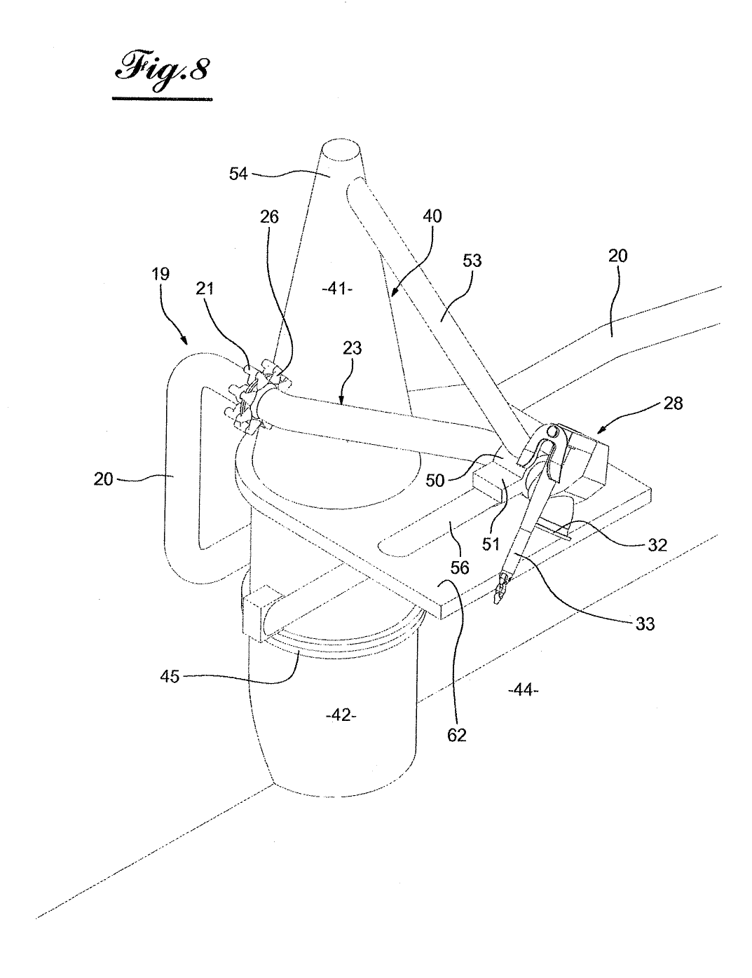

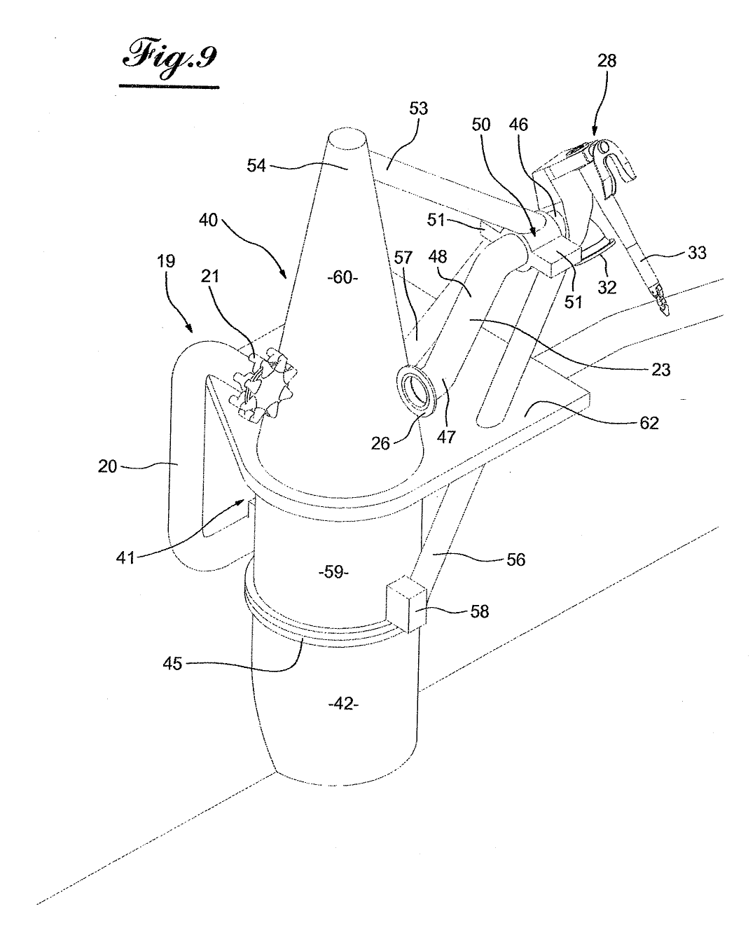

The mobile tubular portion 23 is formed by a tube segment whereof one end supports a clip 26 for connecting to the connecting clip 21 of the fixed tubular portion 20 and the other end of which supports a tip 28 for receiving the connecting tip 14 of a hose 6. In the transfer position of the mobile portion 23, connected to the fixed portion 20, the connecting tip 28 is arranged beyond the edge 30 of the ship, as clearly emerges in particular from FIGS. 6 and 8. The tip 28 essentially comprises a clip 32 for connecting to the hose and, oriented parallel to the axis of the clip, a centering rod called a cone 33. In its position connected to the fixed portion 20, the mobile portion 21, the axis of the clip 32 for connecting to or receiving the hose, and thus the cone 33 are tilted downward in a substantially vertical plane between the edges of the two ships, in the direction moving away from the platform.

In a complementary manner, the connecting tip 14 to the second ship 2 of each hose 6 includes a connector 35 for connecting to the connector 32, a trumpet-shaped member for guiding the tip 36 in its position connected on the clip 32 for receiving the connector 35, and a winch 37 around which a cable 38 is wound for hoisting the tip 35 of the hose to the receiving clip 32. When a transfer connection is established, the hoisting cable is fastened to the tip of the cone 33.

The support device of the mobile tubular portion 23 is made in the form of a turret 40 whereof the upper portion 41 is rotatably mounted around a substantially vertical axis, on a lower portion 42 that is secured to the deck 44 of the ship. The rotation is done, in the illustrated example, using a rotary seal 45.

More specifically, as clearly shown in FIG. 9, the tube segment 23 includes, between the segment 46 supporting the clip 32, which extends substantially horizontally, and its segment supporting the internal connecting clip 26, also extending horizontally, a tilted intermediate section 48.

In the illustrated example, the outer segment 46 is surrounded and held by a piece 50 in the form of a sleeve including two outer lugs 51 that extend horizontally and diametrically from the cylindrical central portion. The tube segment 23 is retained via the piece 50 by an upper bar 53 fixed by an upper end on the central portion of the piece 50 and by the other end to the upper portion 54 of the rotary portion 41 of the turret 40, and by two strips 56 and 57 fixed by one end to the inner surface of one of the lugs 51 and by the other end to a fastening peg 58 provided on the cylindrical lower portion 59 of the rotary portion 41, the upper portion 60 having a conical shape narrowing toward the top. At the junction of the two portions, the turret 40 supports a small horizontal platform 62 above which are positioned, at a certain distance, the connectors 21 and 26 of the fixed 20 and mobile 23 tubular portions, respectively. The support strips 56 and 57 pass through the platform 62.

Owing to the configuration of the mobile segment 23 and its fastening to the turret 40, via the three support strips 53, 56 and 57, that segment, during the rotation of the portion 41 of the turret 40, pivots around the vertical axis of the portion 41 so that its inner connector 26 moves on a trajectory in the shape of an arc of circle on which the connector 21 of the tubular portion 20 is located, so that when they meet, during the establishment of the transfer conditions of a fluid, the axes of the two connectors 21 and 26 are combined so that the connectors can be connected to one another. Thus, the movement of the mobile tubular portion 21 between its rest and transfer positions is done without the intervention of any rotary seal. It is the absence of such a rotary seal that makes it possible to produce the transfer arrangement of the second ship in the form of a very simple structure without any rotary seal in the flow path of the fluid coming from the first storage ship.

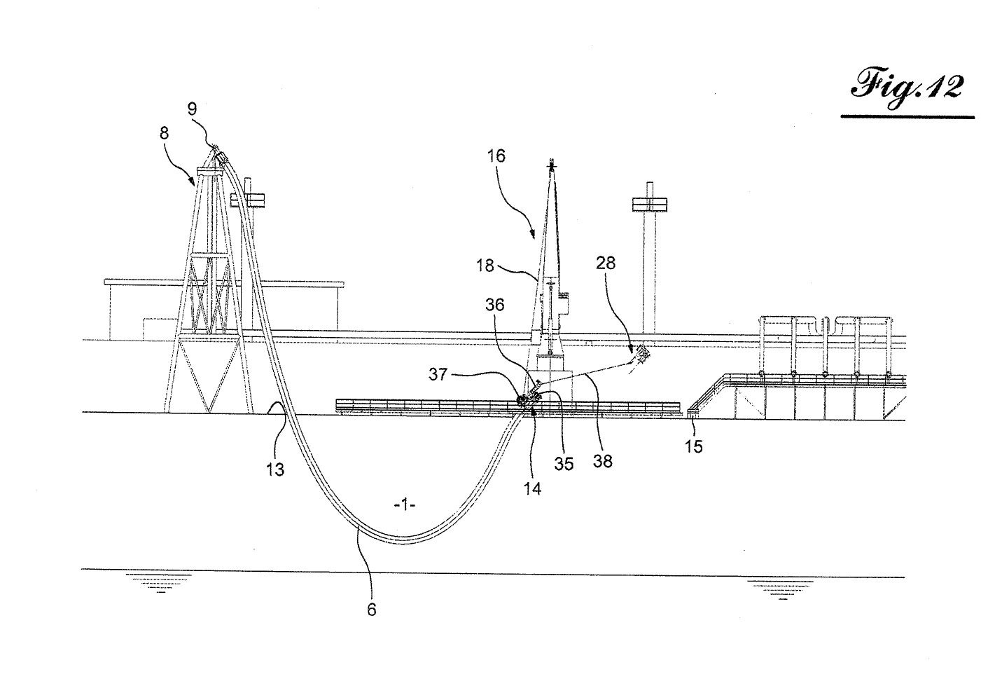

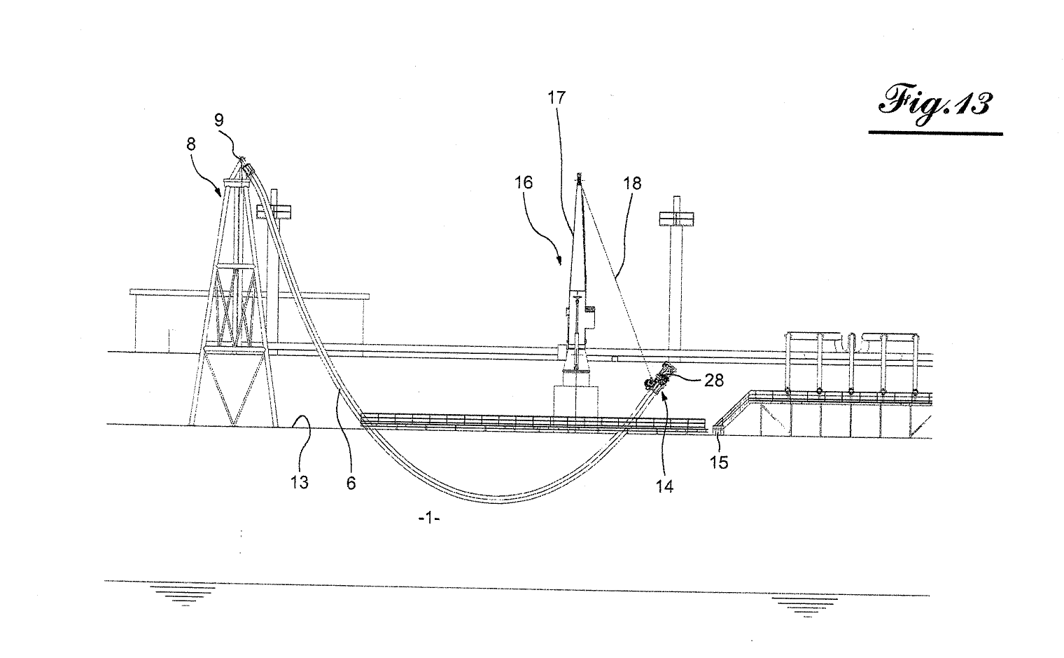

In reference in particular to FIGS. 10 to 13, we will briefly describe below the process of establishing a connection for transferring a fluid between the two ships 1 and 2. As shown in FIG. 10, in its rest position on the first storage ship 1, each hose 6 rests by a large part of its length on the deck 13 of the ship. To establish a transfer connection for a fluid, by connecting the tip 14 thereof to the corresponding connecting tip 28 of the second ship, one first lifts, as shown in particular in FIG. 11, the tip 14 using its handling crane 16, using a cable 18, the hoist cable 38 being partially unwound from its winch 37. After fastening the free end of the hoisting cable to the tip of the cone 32, the tip 14 is pulled toward the connecting tip 28 of the ship, as shown in FIGS. 12 and 13, the trumpet 36 of the tip 14 then engaging on the cone 33 in the last phase of the connection so that the connector 35 of that tip is guided correctly toward the clip 32 of the receiving tip 28. It should be noted that in FIGS. 12 and 13, only the receiving tip 28 is shown to facilitate the understanding of the process of establishing the transfer connection.

One can see that, in the transfer position, the hose 6 connected to the second ship 2 extends in a chain between the two ships in a vertical plane substantially parallel to the longitudinal directions of the two ships. It should be noted that, throughout the entire process of connecting the hose to the second ship, it extends freely between its two ends, which minimizes the mechanical stresses that may be exerted on the hose.

Of course, the implementation of the pivoting movement of the mobile tubular portion of the device for offsetting the manifold advantageously beyond the edge of the ship, which has just been described and is shown in the figures, has been given only as an example and modifications can be made to it without going beyond the scope of the invention. Thus, the configuration of the support turret of the mobile portion as well as its fastening on the support turret can be modified in multiple ways.

1. An arrangement for transferring a fluid to a ship comprising:
a manifold connected to a tank on the ship;
a manifold connector; and
an offsetting device for offsetting the manifold connector at least as far as an outer edge of the ship, wherein
the offsetting device comprises
a fixed tubular portion fixedly mounted on a structure of the ship and connected to the manifold, and
a mobile tubular portion that is movable between a transfer position, in which an outer end of the mobile tubular portion supports the manifold connector, offset and connected to a fluid transfer duct, and a rest position inside the ship, relative to the outer edge of the ship,
the mobile tubular portion is pivotably mounted on the ship, for pivoting between the rest and transfer positions,
outer and inner ends of the fixed and mobile tubular portions include respective first and second connectors that are connected to each other in the transfer position of the mobile tubular portion, and are separated from each other in the rest position of the mobile tubular portion, and
the first connector of the fixed tubular portion is situated on a circle of pivoting movement of the second connector, of the mobile tubular portion, so that axes of opening orifices of the first and second connectors coincide in the transfer position of the mobile tubular portion.

2. The arrangement according to claim 1, including a support on which the mobile tubular portion is mounted, the mobile tubular portion pivoting around a substantially vertical axis of the support.

3. The arrangement according to claim 2, wherein the mobile tubular portion includes a tube segment having a first end supporting the second connector and a second end supporting a connecting tip for connection to the fluid transfer duct.

4. The arrangement according to claim 2, wherein the support includes a turret pivotably mounted around a vertical axis, on the ship.

5. The arrangement according to claim 4, wherein the turret includes a rotary upper portion and a base portion fixedly mounted on the ship.

6. A system for transferring fluids from a first ship to a second ship, with the first and second ships located side-by-side, the system comprising first and second transfer arrangements respectively positioned on the first and second ships, and at least one flexible transfer duct interconnecting the first and second transfer arrangements during transfer of a fluid between the first and second ships, wherein the second ship includes a transfer arrangement according to claim 1.

7. The system according to claim 6, wherein the flexible transfer duct extends in a catenary between ends connected to the transfer arrangements of the first and second ships, in a plane extending between the first and second ships.

8. The system according to claim 7, wherein
the first transfer arrangement on the first ship includes a tower structure having an apex where the flexible transfer duct is connected to a fixed pipeline, and a crane for moving a free tip of the flexible transfer duct to the second transfer arrangement of the second ship,
the flexible transfer duct extends, at rest, between the apex of the tower structure and a deck of the first ship and rests on the deck of the first ship, along an edge of the first ship.

9. The system according claim 6, wherein the flexible transfer duct is a cryogenic hose.

10. The arrangement according to claim 3, wherein the support includes a turret pivotably mounted around a vertical axis, on the ship.

11. The arrangement according to claim 10, wherein the turret includes a rotary upper portion and a base portion fixedly mounted on the ship.
